(19) United States
(12) Patent Application Publication
(10) Pub. No.: US 2026/0055222 A1
(43) Pub. Date: Feb. 26, 2026

(54) PHOTOCURABLE COMPOSITION AND ITS APPLICATION IN PHOTOCURING FIELDS

(71) Applicant: HUIZHOU HUAHONG NEW MATERIALS CO., LTD., Huizhou (CN)

(72) Inventors: Jianxiong LIN, Huizhou (CN); Qiang LIU, Huizhou (CN); Xuefei ZHENG, Huizhou (CN); Akira SHIRAHATA, Huizhou (CN); Nobuo KABAMOTO, Huizhou (CN); Yumi SAITO, Huizhou (CN); Jianyu YANG, Huizhou (CN)

(73) Assignee: HUIZHOU HUAHONG NEW MATERIALS CO., LTD., Huizhou (CN)

(21) Appl. No.: 19/305,601

(22) Filed: Aug. 20, 2025

(30) Foreign Application Priority Data
Aug. 21, 2024 (CN) 202411155162.2

(51) Int. Cl. C08F 222/10; C08F 2/50; C08F 283/10; C08K 3/26; C08K 3/36; C08K 5/17; C08K 5/357; C08K 5/45; C09D 7/61; C09D 7/63; C09D 7/65; C09D 11/037; C09D 11/101; C09D 163/10

(52) U.S. Cl. CPC C08F 222/104; C08F 2/50; C08F 283/105; C08K 3/26; C08K 3/36; C08K 5/17; C08K 5/357; C08K 5/45; C09D 7/61; C09D 7/63; C09D 7/65; C09D 11/037; C09D 11/101; C09D 163/10; C08K 2003/265

(57) ABSTRACT

The present invention generally relates to a photosensitive material. More particularly it relates to a photosensitive composition comprising a photoinitiator compound having a structure (I) and at least one monomer/oligomer wherein the monomer/oligomer is having photopolymerizable ethylenic unsaturated double bonds and its application in the field of photosensitive curing.

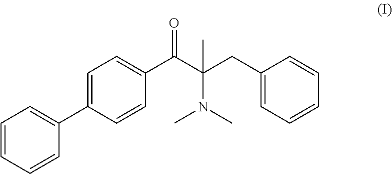 [SMILES: CN(C)C(C)(Cc1ccccc1)C(=O)c1ccc(-c2ccccc2)cc1]

### FIELD OF THE INVENTION

The present invention generally relates to a photosensitive composition. More particularly it relates to a photosensitive composition comprising a photoinitiator compound having a structure (I) and at least one monomer/oligomer wherein the monomer/oligomer is having photopolymerizable ethylenic unsaturated double bonds and its application in the field of photosensitive curing.

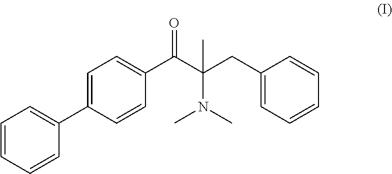 [SMILES: CN(C)C(C)(Cc1ccccc1)C(=O)c1ccc(-c2ccccc2)cc1]

### BACKGROUND OF THE INVENTION

Photosensitive curing technology is an efficient and environmentally friendly manufacturing process that triggers the polymerization reaction in the material through the irradiation of specific wavelengths of light on the photoinitiator, achieving rapid curing of the material. This technology has been widely used in 3D printing, electronic material preparation, coatings, and inks. As a key component of the photosensitive system, the photoinitiator has a decisive impact on curing efficiency, product performance, and environmental effects.

Despite the many advantages of photosensitive curing technology, the photoinitiators currently in use have some limitations. The widespread detection of commercial photoinitiators (PIs) in the environment and human body indicates that these chemical substances may migrate into food through food packaging materials, or affect the ecosystem and human health through environmental media such as water, sediments, sewage sludge, and indoor dust. In addition, toxicity studies on some photoinitiators have revealed their potential carcinogenicity and endocrine-disrupting effects, raising concerns about environmental and public health issues.

For example, existing photoinitiators such as ketones, benzoyl compounds, and phosphates are commonly used in various photosensitive resin compositions. However, these initiators can cause environmental pollution in practical applications. For instance, benzoyl initiators release volatile organic compounds (VOCs) during the photosensitive curing process, which are harmful to the environment and may pose health risks to humans. Moreover, certain initiators can cause yellowing of the product surface during curing, affecting the appearance quality and market acceptance of the product. These yellowing phenomena are mainly due to the color of the decomposition products of the initiator or the residual unreacted initiator. Finally, some photoinitiators produce odors during the curing process, which is unacceptable for high-demand printed materials such as food packaging and pharmaceutical packaging.

To address these issues, researchers have been committed to developing new environmentally friendly photoinitiators. For example, photoinitiators with the codes 369, 379, and 389 have been used in photosensitive curing, and overall, these initiators have lower migration, solving the problem of existing photoinitiators releasing toxic and malodorous photodegradation products.

However, as research deepens, the field has gradually discovered some shortcomings of these initiators. For example, the initiator system formed by 379 initiator usually has a high concentration, which makes it difficult to evenly coat or fill complex-shaped molds, thus reducing processing performance. Also, the ultraviolet absorption range of 379 initiator is relatively narrow, mainly concentrated around 365 nm. This limits its use in applications that require a wider range of wavelengths or different wavelengths of ultraviolet light sources and LED light sources. In some applications, 379 initiator may cause the color of the cured material to yellow, especially under high-temperature or long-term light exposure conditions. This may affect the appearance quality and user experience of the final product. Compared with traditional photoinitiators, the production cost of 379 initiator is higher, which may increase the cost of the final product and thus lack competitiveness in some price-sensitive markets.

In addition, although 379 initiator has low odor during use, its chemical composition may still pose certain toxicity and hazards to humans and the environment. It is particularly important to note that the structure of 379 initiator contains benzene amine-like compounds. Benzene amine and similar compounds are listed on the European Union's list of Substances of Very High Concern (SVHC). According to the EU REACH regulation (Registration, Evaluation, Authorisation and Restriction of Chemicals), the use of any products containing benzene amine and similar compounds will be strictly controlled. Especially in the field of packaging ink printing, according to the EU CLP regulation (Classification, Labelling and Packaging), benzene amine is classified as a carcinogen (Carcinogenic, Category 1B), and it is necessary to classify, label, and package chemicals containing benzene amine structure to ensure safe use. This greatly restricts the use of 379 initiator.

Therefore, it is necessary to develop a new initiator system that does not contain benzene amine-like structures and can provide better printing effects.

### SUMMARY OF THE INVENTION

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below. Further, features which are described in the context of separate aspects and embodiments of the invention may be used together and/or be interchangeable. Similarly, features described in the context of a single embodiment may also be provided separately or in any suitable sub-combination.

The present invention generally relates to a new type of photosensitive composition that is environmentally friendly, non-toxic, and does not contain benzene amine-like structures, aiming to solve the problem of environmental and human health unfriendliness caused by the presence of benzene amine or similar compounds in photoinitiators in the current photosensitive curing industrial applications.

The present invention more particularly relates to a photosensitive composition comprising a photoinitator compound having a structure (I) and at least one monomer/oligomer wherein the monomer/oligomer is having photopolymerizable ethylenic unsaturated double bonds and its application in the field of photosensitive curing.

According to an embodiment of the invention there is provided a photosensitive composition, comprising: a photoinitiator compound with the following structure I (initiator 979)

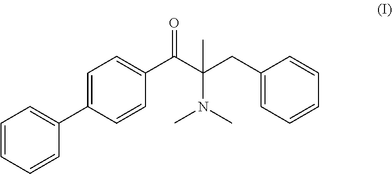 [SMILES: CN(C)C(C)(Cc1ccccc1)C(=O)c1ccc(-c2ccccc2)cc1]

and at least one monomer/oligomer wherein the monomer/oligomer is having photopolymerizable ethylenic unsaturated double bonds and wherein the photoinitiator compound is in the range of 1-14% of the weight of the photosensitive composition.

According to an embodiment of the invention the photoinitiator compound is in the range of preferably 2-8% of the weight of the photosensitive composition.

According to an embodiment of the invention the photosensitive composition of the present invention comprises photoinitiator initiator 979, and wherein the said photosensitive composition does not contain benzene amine-like structures, and at the same time does not reduce the surface curing effect under the premise of reducing potential pollution risks. Further, photosensitive composition obtained using 979 as the initiator has beneficial effects such as the viscosity of the composition is significantly reduced, the fluidity is significantly improved, and the degree of yellowing is also lower.

According to an embodiment of the invention the photosensitive composition provided by the present invention does not produce odors during the curing process, making the printed materials obtained through this invention more suitable for use in industries with higher odor requirements, such as food and cosmetics.

According to an embodiment of the invention the photosensitive composition provided by the present invention another photosensitive initiator may be added which is a first co-initiator. The first co-initiator may be a thioxanthone derivative and wherein the first co-initiator is in the range of 1-5% of the weight of the photosensitive composition.

According to an embodiment of the invention the first co-initiator of the photosensitive composition has one or more of the following structures:

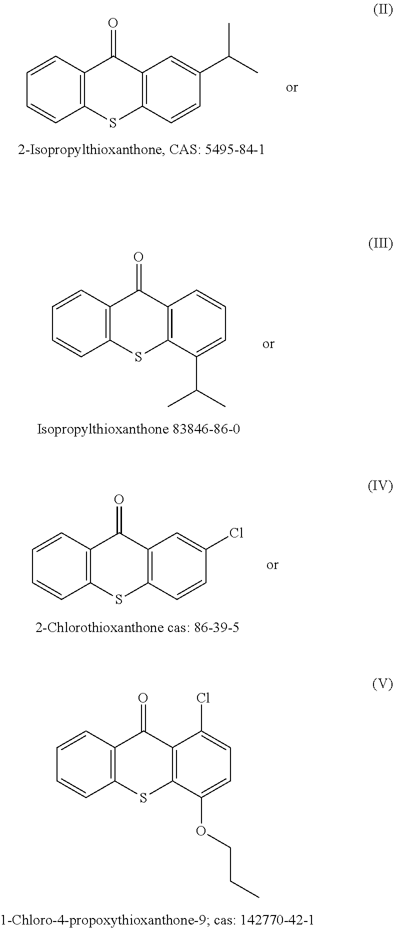 [SMILES: CC(C)c1ccc2sc3ccccc3c(=O)c2c1 ; CC(C)c1cccc2c(=O)c3ccccc3sc12 ; O=c1c2ccccc2sc2ccc(Cl)cc12 ; CCCOc1ccc(Cl)c2c(=O)c3ccccc3sc12]

According to an embodiment of the invention the second co-initiator of the photosensitive composition, more preferably has the following structure (initiator DETX):

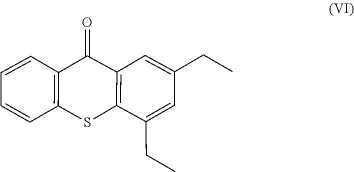 [SMILES: CCc1cc(CC)c2sc3ccccc3c(=O)c2c1]

According to an embodiment of the invention in the photosensitive composition a second co-initiator may be added wherein the second co-initiator is an amine co-initiator, which is in the range of 1-5% of the weight of the photosensitive composition. It can be one or more of the following structures:

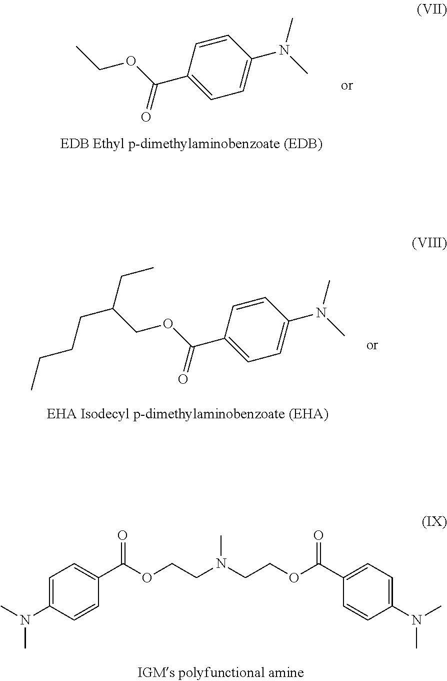

According to an embodiment of the invention in the photosensitive composition the structure of the said amine co-initiator more preferably is initiator EMK:

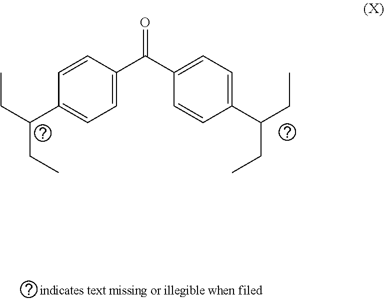 [SMILES: CCC(CC)c1ccc(C(=O)c2ccc(C(CC)CC)cc2)cc1]

According to an embodiment of the invention the addition of one or more co-initiators which are amine co-initiators or thioxanthone derivatives further makes the photosensitive composition provided by the present invention to have excellent curing effects even when using LED light sources, especially when synergistically interacting with initiator 979.

According to an embodiment of the invention the photosensitive composition provided by the present invention may comprise a third co-initiator. The third co-initiator may be in the range of 1-8% of the weight of the photosensitive composition, and the third co-initiator is a 2-morpholinyl-1-propanone derivative. Preferably, the third co-initiator can be one or two of the following structures:

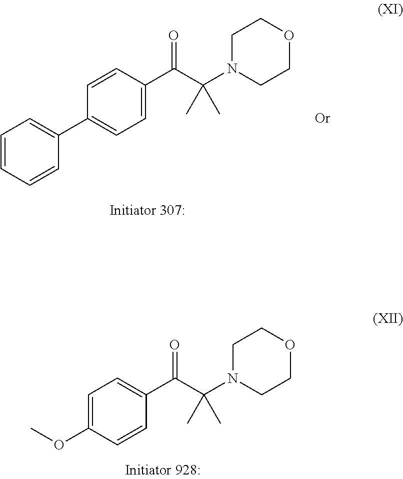 [SMILES: CC(C)(C(=O)c1ccc(-c2ccccc2)cc1)N1CCOCC1 ; COc1ccc(C(=O)C(C)(C)N2CCOCC2)cc1]

According to another embodiment of the invention the addition of a third co-initiator such as initiator 928 or initiator 307 can significantly reduce the viscosity of the system and control the viscosity of the system at a more suitable processing level, thereby significantly improving the processability. Furthermore, the photosensitive composition provided by the present invention has low viscosity, solving the problem that the use of initiator 379 system with high viscosity limits the industrial application scenarios.

According to another embodiment of the invention the photosensitive composition provided by the present invention may further comprise of an allyl ester prepolymer, wherein the allyl ester prepolymer may be taken in the range of 10-60% of the weight of the photosensitive composition. Preferably, the allyl ester prepolymer can be one or more of the following: Diallyl phthalate prepolymer, Diallyl isophthalate prepolymer, Diallyl cyclohexane-1,4-dicarboxylate prepolymer. The addition of allyl ester prepolymer can significantly accelerate the reaction curing speed.

According to another embodiment of the invention, in the photosensitive composition, the monomer/oligomer is an ethylenic unsaturated photopolymerizable compound which can be a compound with one carbon-carbon double bond or two or more carbon-carbon double bonds, and can be used alone or in combination with monofunctional, bifunctional, or multifunctional monomers. The reaction baseness or molecular weight is not particularly limited and can be appropriately combined according to the desired properties.

According to another embodiment of the invention the ethylenic unsaturated photopolymerizable compound is preferably an acrylate or methacrylate compound; specifically, it can be a monofunctional acrylate, polyfunctional acrylate, or polymerizable oligomer. For example, it can be (meth)acrylic acid ethyl ester, (meth)acrylic acid butyl ester, (meth)acrylic acid 2-ethylhexyl ester, (meth)acrylic acid nonyl ester, (meth)acrylic acid lauryl ester, (meth)acrylic acid tridecyl ester, (meth)acrylic acid hexadecyl ester, (meth)acrylic acid octadecyl ester, (meth)acrylic acid isopentyl ester, (meth)acrylic acid isodecyl ester, (meth)acrylic acid isostearate, (meth)acrylic acid cyclohexyl ester, (meth)acrylic acid benzyl ester, (meth)acrylic acid methoxyethyl ester, (meth)acrylic acid butoxyethyl ester, (meth)acrylic acid phenoxyethyl ester, phenoxy-diethylene glycol (meth)acrylate, (meth)acrylic acid nonylphenoxymethyl ester, (meth)acrylic acid tetrahydrofurfuryl ester, (meth)acrylic acid glycidyl ester, (meth)acrylic acid 2-hydroxyethyl ester, (meth)acrylic acid 2-hydroxy-3-phenoxypropyl ester, (meth)acrylic acid 3-chloro-2-hydroxypropyl ester, (meth)acrylic acid diethylaminoethyl ester, (meth)acrylic acid nonylphenoxymethyl tetrahydrofurfuryl ester, caprolactone-modified (meth)acrylic acid tetrahydrofurfuryl ester, (meth)acrylic acid isobornyl ester, (meth)acrylic acid dicyclopentyl ester, (meth)acrylic acid dicyclopentenyl-oxyethyl ester, 1,4-butanediol di(meth)acrylate, 3-methyl-1,5-pentanediol di(meth)acrylate, 1,6-hexanediol di(meth)acrylate, neopentyl glycol di(meth)acrylate, 2-methyl-1,8-octanediol di(meth)acrylate, 2-butyl-2-ethyl-1,3-propanediol di(meth)acrylate, dicyclohexyl-methane-4,4′-di(meth)acrylate, ethylene glycol di(meth)acrylate, diethylene glycol di(meth)acrylate, triethylene glycol di(meth)acrylate, dipropylene glycol di(meth)acrylate, tripropylene glycol di(meth)acrylate, polyethylene glycol di(meth)acrylate, polypropylene glycol di(meth)acrylate, tris(2-hydroxyethyl)isocyanurate di(meth)acrylate, modified polyether acrylate, amine-modified epoxy acrylate, amine-modified aliphatic acrylate, amine-modified polyester acrylate, amino(meth)acrylate, etc., amine-modified acrylate, thiol-modified polyester acrylate, thiol(meth)acrylate, etc., thiol-modified acrylate, polyester(meth)acrylate, polyether (meth)acrylate, polyolefin(meth)acrylate, polystyrene(meth)acrylate, epoxy(meth)acrylate, amino(meth)acrylate, etc.

According to yet another embodiment of the invention the photosensitive composition provided by the present invention is applicable to protective coatings, decorative coatings, or imaging exposure etching images on all kinds of substrate materials, including but not limited to various plastic materials such as polystyrene, polypropylene, polyvinyl chloride, etc.; wood, including natural wood and wood fiber boards; metal materials such as aluminum, steel, copper, etc.; glass, including flat glass, tempered glass, etc.; ceramic materials such as tiles, porcelain, etc.; stone materials such as marble, granite, etc.; paper and cardboard; fabrics and textiles; rubber and elastomer materials, etc.

According to yet another embodiment of the invention the photosensitive composition provided by the present invention can be in the form of a film and can be used on the above substrates as protective coatings, decorative coatings, or imaging exposure etching images.

According to yet another embodiment of the invention the present invention also provides the application of the photosensitive composition wherein it is used for the manufacture of printing packaging, electronic adhesives, automotive coatings, building materials, medical devices, dental restorative materials, optical fiber communication coatings, aerospace composite materials, wood coatings, printed circuit boards, optical elements, solar panels, mobile phone screens, display coatings, eyeglass lens coatings, safety glass, anti-counterfeiting labels, textiles, leather products, paper, plastic products, metal anti-corrosion coatings, household appliances, lighting fixtures, automotive interiors, ship interior parts, electronics, jewelry, colored and uncolored paints and varnishes, powder coatings, dental compositions, gel coatings, photoresists for electronic devices, electroplating resists, etching resists, liquid and dry films, welding resists, photoresists for manufacturing color filters used in various display applications, structures used in the manufacturing methods of plasma display panels, electro luminescent displays and LCD resists, for LCD, holographic data storage, compositions for encapsulating electronic components, for preparing magnetic recording materials, micro-mechanical parts, waveguides, optical switches, forging and covering masks, etching masks, color proofing systems, glass fiber cable coatings, silk screen printing templates, for producing three-dimensional objects using stereolithography, as image recording materials, for holographic recording, microelectronic circuits, decolorizing materials, decolorizing materials for image recording materials, and decolorizing materials used in image recording materials with microcapsules.

According to yet another embodiment of the invention the photosensitive composition of the present invention in combination with various different construction methods (such as spraying, rolling, pouring, wiping, dipping, etc.) and/or construction processes (such as putty, primer, coloring, intermediate coat, top coat, etc.), has extremely broad application value in downstream markets such as wooden furniture, plastic products, printing packaging, inkjet printing, electronic consumer goods, vehicle interiors and exteriors, pipeline profiles, industrial floors, building curtain walls, 3D printing additive manufacturing, and ships or container bodies.

In yet another embodiment of the invention the photosensitive composition of the present invention is used for curing wherein the examples of light sources include germicidal lamps, ultraviolet fluorescent lamps, ultraviolet-emitting diodes (UV-LEDs), carbon arcs, xenon lamps, high-pressure mercury lamps, medium-pressure mercury lamps, super-high-pressure mercury lamps, electrode-less lamps, metal halide lamps, LED lamps, and natural light. For the aforementioned UV-LEDs, it is preferable that the peak wavelength is around 350-420 nm, more preferably in the range of 350-400 nm, and the cumulative light quantity is preferably about 5 mJ/cm²-200 mJ/cm², more preferably 10-100 mJ/cm². Moreover, the appropriate irradiation intensity (mW/cm²) of the light source will vary depending on the number of light sources arranged along the printing direction, the irradiation distance from the light source to the composition, and other conditions, so there is no specific regulation. However, in the printing method described above, the moving speed of the printing substrate is about 60-400 m/min, so for the photosensitive composition on the printing substrate moving at this printing speed, the irradiation intensity that results in the aforementioned cumulative light quantity value is preferred.

In yet another embodiment of the invention the technical improvement effects of the present invention are positive and significant when compared with the known existing products. The photosensitive composition provided by the present invention is an environmentally friendly, easy-to-process, widely curable, and non-toxic system, avoiding problems such as yellowing during the photosensitive curing process, or the generation of stimulating and unpleasant odors, or compound migration causing physiological toxicity, and has a good promoting effect on the application and promotion in the field of ultraviolet radiation photosensitive curing.

### DETAILED DESCRIPTION OF THE INVENTION

Discussed below are some representative embodiments of the present invention. The invention in its broader aspects is not limited to the specific details and representative methods. The illustrative examples are described in this section in connection with the embodiments and methods provided. The invention according to its various aspects is particularly pointed out and distinctly claimed in the attached claims read in view of this specification.

It should be noted that the features in the implementation examples of the present invention can be combined with each other. The following specifically describes the present invention through implementation examples, and the implementation examples do not constitute a limitation to the technical solutions protected by the present invention. Technical personnel in the field are fully capable of modifying the shown implementation examples within the framework of the present invention to obtain the same or similar effects and conclusions.

As used in this specification, unless otherwise specified, “a” means “at least one” or “one or more”. In addition, unless the content clearly states otherwise, a composition containing compounds includes a mixture of two or more compounds. As used in the specification and appended claims, the term “or” is generally used in the sense of “and/or” unless the content clearly expresses otherwise.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic. Also, references to the term “comprising” may also include the case of “consisting of” and ‘consisting essentially of’ and may be used interchangeably.

It should be understood that unless otherwise specified, all numerical values indicating the quantity of components, property values such as ratios, etc., in the specification and claims can be modified by the term “about”. Therefore, unless there is a contrary indication, the numerical parameters described above are approximate values, which can vary according to the desired properties that technical personnel in the field intend to achieve using the teachings of the present invention. At the very least, the application of the doctrine of equivalents should not be limited to the scope of the claims, and at least the numerical parameters should be interpreted based on the number of significant FIGURES reported and using conventional rounding techniques. Although the numerical ranges and parameters that describe the broad scope of the invention are approximate values, the numerical values listed in the specific implementation examples are reported as precisely as possible. However, any numerical value inevitably contains a certain degree of error, which is necessarily caused by the standard deviation in the respective test measurements.

The present invention, in its product and process aspects, is described in detail as follows.

The present invention generally relates to a new type of photosensitive composition that is environmentally friendly, non-toxic, and does not contain benzene amine-like structures, aiming to solve the problem of environmental and human health unfriendliness caused by the presence of benzene amine or similar compounds in photoinitiators in the current photosensitive curing industrial applications.

The present invention more particularly relates to a photosensitive composition comprising a photoinitiator compound having a structure (I) and at least one monomer/oligomer wherein the monomer/oligomer is having photopolymerizable ethylenic unsaturated double bonds and its application in the field of photosensitive curing.

The photosensitive composition is comprising: a photoinitiator compound with the following structure I (initiator 979)

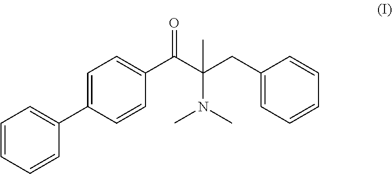 [SMILES: CN(C)C(C)(Cc1ccccc1)C(=O)c1ccc(-c2ccccc2)cc1]

and at least one monomer/oligomer wherein the monomer/oligomer is having photopolymerizable ethylenic unsaturated double bonds, wherein the photoinitiator compound is in the range of 1-14% of the weight of the photosensitive composition.

In an embodiment of the invention the photoinitiator compound is in the range of preferably 2-8% of the weight of the photosensitive composition.

In an embodiment of the invention the photosensitive composition of the present invention comprises of photoinitiator initiator 979 and achieves effective surface curing effect without any reduction in curing performance, while simultaneously reducing potential pollution risks when compared to the presence of benzene amine-like structures in the known compositions. Further, photosensitive composition of the present invention prepared using 979 as the initiator has beneficial effects such as the viscosity of the composition is significantly reduced, the fluidity is significantly improved, and the degree of yellowing is also lower. Moreover, the photosensitive composition provided by the present invention does not produce odors during the curing process, making the printed materials obtained through this invention more suitable for use in industries with higher odor requirements, such as food and cosmetics.

According to an embodiment of the invention in the composition provided by the present invention another photosensitive initiator may be added which is a first co-initiator. The said first co-initiator may be a thioxanthone derivative and wherein the second co-initiator is in the range of 1-5% of the weight of the photosensitive composition.

According to an embodiment of the invention the first co-initiator of the photosensitive composition has one or more of the following structures:

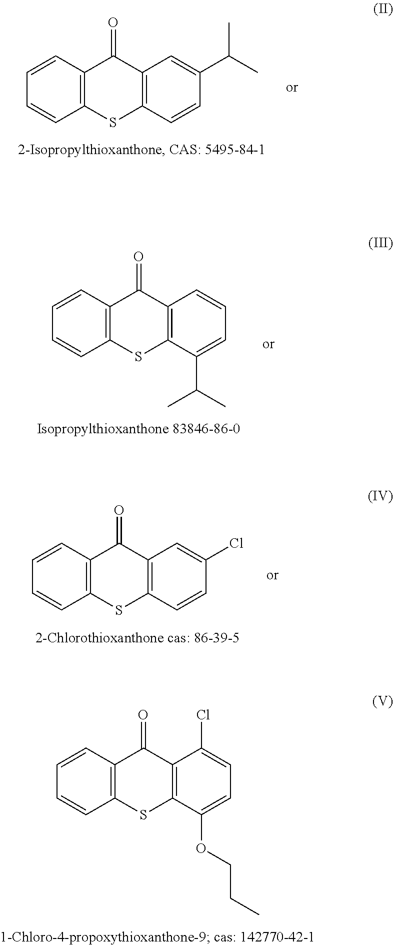 [SMILES: CC(C)c1ccc2sc3ccccc3c(=O)c2c1 ; CC(C)c1cccc2c(=O)c3ccccc3sc12 ; O=c1c2ccccc2sc2ccc(Cl)cc12 ; CCCOc1ccc(Cl)c2c(=O)c3ccccc3sc12]

According to an embodiment of the invention the first co-initiator of the photosensitive composition, more preferably has the following structure (initiator DETX):

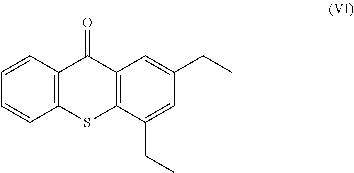 [SMILES: CCc1cc(CC)c2sc3ccccc3c(=O)c2c1]

According to an embodiment of the invention in the photosensitive composition a second co-initiator may be added wherein the second co-initiator is an amine co-initiator, which is in the range of 1-5% of the weight of the photosensitive composition.

It can have one or more of the following structures:

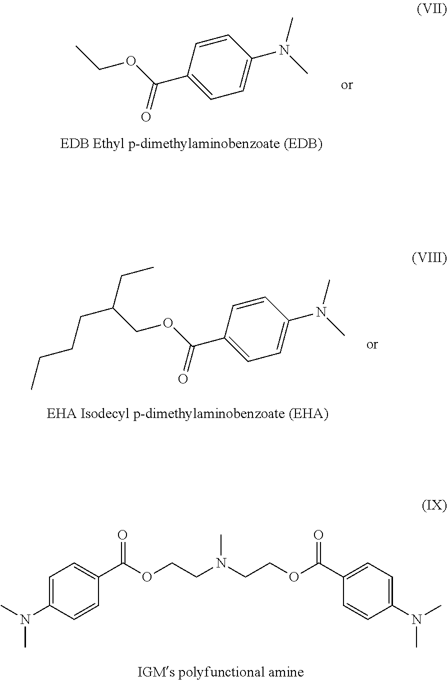

According to an embodiment of the invention in the photosensitive composition the structure of the amine co-initiator more preferably is (initiator EMK):

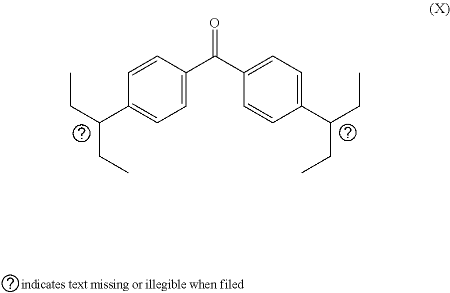 [SMILES: CCC(CC)c1ccc(C(=O)c2ccc(C(CC)CC)cc2)cc1]

The addition of one or more co-initiators which are amine co-initiators or thioxanthone derivatives further makes the photosensitive composition provided by the present invention to have excellent curing effects even when using LED light sources, especially when synergistically interacting with initiator 979.

In an embodiment of the invention the photosensitive composition provided by the present invention may comprise a third co-initiator. The third co-initiator may be present in the range of 1-8% of the weight of the photosensitive composition, and the third co-initiator is a 2-morpholinyl-1-propanone derivative. Preferably, the third co-initiator can be one or two of the following structures:

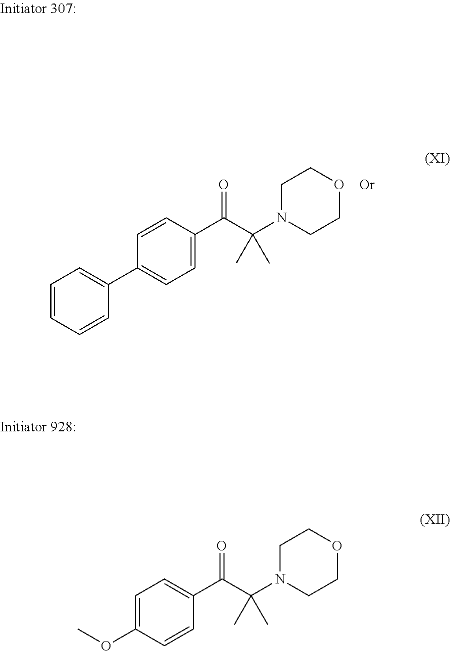

The addition of initiator 928 or initiator 307 can significantly reduce the viscosity of the system and control the viscosity of the system at a more suitable processing level, thereby significantly improving the processability. Furthermore, the photosensitive composition provided by the present invention has low viscosity, solving the problem that the use of initiator 379 system with high viscosity limits the industrial application scenarios.

In an embodiment of the invention the photosensitive composition provided by the present invention may further comprise of an allyl ester prepolymer, wherein the allyl ester prepolymer may be taken in the range of 10-60% of the weight of the photosensitive composition. Preferably, the allyl ester prepolymer can be one or more of the following: Diallyl phthalate prepolymer, Diallyl isophthalate prepolymer, Diallyl cyclohexane-1,4-dicarboxylate prepolymer. The addition of allyl ester prepolymer can significantly accelerate the reaction curing speed.

According to another embodiment of the invention, in the photosensitive composition, the monomer is an ethylenic unsaturated photopolymerizable compound, which can be a compound with one carbon-carbon double bond or two or more carbon-carbon double bonds, and can be used alone or in combination with monofunctional, bifunctional, or multifunctional monomers. The reaction baseness or molecular weight is not particularly limited and can be appropriately combined according to the desired properties. Further, the ethylenic unsaturated photopolymerizable compound is preferably an acrylate or methacrylate compound; specifically, it can be a monofunctional acrylate, polyfunctional acrylate, or polymerizable oligomer. For example, it can be (meth)acrylic acid ethyl ester, (meth)acrylic acid butyl ester, (meth)acrylic acid 2-ethylhexyl ester, (meth)acrylic acid nonyl ester, (meth)acrylic acid lauryl ester, (meth)acrylic acid tridecyl ester, (meth)acrylic acid hexadecyl ester, (meth)acrylic acid octadecyl ester, (meth)acrylic acid isopentyl ester, (meth)acrylic acid isodecyl ester, (meth)acrylic acid isostearate, (meth)acrylic acid cyclohexyl ester, (meth)acrylic acid benzyl ester, (meth)acrylic acid methoxyethyl ester, (meth)acrylic acid butoxyethyl ester, (meth)acrylic acid phenoxyethyl ester, phenoxy-diethylene glycol (meth)acrylate, (meth)acrylic acid nonylphenoxymethyl ester, (meth)acrylic acid tetrahydrofurfuryl ester, (meth)acrylic acid glycidyl ester, (meth)acrylic acid 2-hydroxyethyl ester, (meth)acrylic acid 2-hydroxy-3-phenoxypropyl ester, (meth)acrylic acid 3-chloro-2-hydroxypropyl ester, (meth)acrylic acid diethylaminoethyl ester, (meth)acrylic acid nonylphenoxymethyl tetrahydrofurfuryl ester, caprolactone-modified (meth)acrylic acid tetrahydrofurfuryl ester, (meth)acrylic acid isobornyl ester, (meth)acrylic acid dicyclopentyl ester, (meth)acrylic acid dicyclopentenyl-oxyethyl ester, 1,4-butanediol di(meth)acrylate, 3-methyl-1,5-pentanediol di(meth)acrylate, 1,6-hexanediol di(meth)acrylate, neopentyl glycol di(meth)acrylate, 2-methyl-1,8-octanediol di(meth)acrylate, 2-butyl-2-ethyl-1,3-propanediol di(meth)acrylate, dicyclohexyl-methane-4,4′-di(meth)acrylate, ethylene glycol di(meth)acrylate, diethylene glycol di(meth)acrylate, triethylene glycol di(meth)acrylate, dipropylene glycol di(meth)acrylate, tripropylene glycol di(meth)acrylate, polyethylene glycol di(meth)acrylate, polypropylene glycol di(meth)acrylate, tris(2-hydroxyethyl)isocyanurate di(meth)acrylate, modified polyether acrylate, amine-modified epoxy acrylate, amine-modified aliphatic acrylate, amine-modified polyester acrylate, amino(meth)acrylate, etc., amine-modified acrylate, thiol-modified polyester acrylate, thiol(meth)acrylate, etc., thiol-modified acrylate, polyester(meth)acrylate, polyether (meth)acrylate, polyolefin(meth)acrylate, polystyrene(meth)acrylate, epoxy(meth)acrylate, amino(meth)acrylate, etc.

The photosensitive composition provided by the present invention is applicable to protective coatings, decorative coatings, or imaging exposure etching images on all kinds of substrate materials, including but not limited to various plastic materials such as polystyrene, polypropylene, polyvinyl chloride, etc.; wood, including natural wood and wood fiber boards; metal materials such as aluminum, steel, copper, etc.; glass, including flat glass, tempered glass, etc.; ceramic materials such as tiles, porcelain, etc.; stone materials such as marble, granite, etc.; paper and cardboard; fabrics and textiles; rubber and elastomer materials, etc.

In an embodiment of the invention the photosensitive composition provided by the present invention can be in the form of a film and can be used on the above substrates as protective coatings, decorative coatings, or imaging exposure etching images.

In another embodiment of the invention the photosensitive composition of the present invention is used for the manufacture of printing packaging, electronic adhesives, automotive coatings, building materials, medical devices, dental restorative materials, optical fiber communication coatings, aerospace composite materials, wood coatings, printed circuit boards, optical elements, solar panels, mobile phone screens, display coatings, eyeglass lens coatings, safety glass, anti-counterfeiting labels, textiles, leather products, paper, plastic products, metal anti-corrosion coatings, household appliances, lighting fixtures, automotive interiors, ship interior parts, electronics, jewelry, colored and uncolored paints and varnishes, powder coatings, dental compositions, gel coatings, photoresists for electronic devices, electroplating resists, etching resists, liquid and dry films, welding resists, photoresists for manufacturing color filters used in various display applications, structures used in the manufacturing methods of plasma display panels, electro luminescent displays and LCD resists, for LCD, holographic data storage, compositions for encapsulating electronic components, for preparing magnetic recording materials, micro-mechanical parts, waveguides, optical switches, forging and covering masks, etching masks, color proofing systems, glass fiber cable coatings, silk screen printing templates, for producing three-dimensional objects using stereolithography, as image recording materials, for holographic recording, microelectronic circuits, decolorizing materials, decolorizing materials for image recording materials, and decolorizing materials used in image recording materials with microcapsules.

In yet another embodiment of the invention the photosensitive composition of the present invention in combination with various different construction methods (such as spraying, rolling, pouring, wiping, dipping, etc.) and/or construction processes (such as putty, primer, coloring, intermediate coat, top coat, etc.), has extremely broad application value in downstream markets such as wooden furniture, plastic products, printing packaging, inkjet printing, electronic consumer goods, vehicle interiors and exteriors, pipeline profiles, industrial floors, building curtain walls, 3D printing additive manufacturing, and ships or container bodies.

In yet another embodiment of the invention the photosensitive composition of the present invention is used for curing wherein the examples of light sources include germicidal lamps, ultraviolet fluorescent lamps, ultraviolet-emitting diodes (UV-LEDs), carbon arcs, xenon lamps, high-pressure mercury lamps, medium-pressure mercury lamps, super-high-pressure mercury lamps, electrode-less lamps, metal halide lamps, LED lamps, and natural light. For the aforementioned UV-LEDs, it is preferable that the peak wavelength is around 350-420 nm, more preferably in the range of 350-400 nm, and the cumulative light quantity is preferably about 5 mJ/cm2-200 mJ/cm2, more preferably 10-100 mJ/cm2. Moreover, the appropriate irradiation intensity (mW/cm2) of the light source will vary depending on the number of light sources arranged along the printing direction, the irradiation distance from the light source to the composition, and other conditions, so there is no specific regulation. However, in the printing method described above, the moving speed of the printing substrate is about 60-400 m/min, so for the photosensitive composition on the printing substrate moving at this printing speed, the irradiation intensity that results in the aforementioned cumulative light quantity value is preferred.

The photosensitive composition of the present invention may be utilized in the above-mentioned applications through the incorporation of additional known components such as additives, and pigments. Additives are a class of chemical substances used to improve the performance of materials or products, including stabilizers, antioxidants, plasticizers, fillers, abrasion-resistant agents, viscosity regulators, etc. The photosensitive composition disclosed herein may include one or more such additives, depending on the specific application requirements.

A stabilizer used in the context of present invention refers to a chemical substance that can increase the stability of solutions, colloids, solids, mixtures, etc. In the printing industry, stabilizers are mainly used to prevent inks, plastic films, and other materials from decomposing or aging due to heat, light, or oxidation during processing or use, thereby maintaining the quality and stability of printed products. Common stabilizers include mono-hydroxybenzene, dihydroxybenzene, p-phenylenediamine, p-aminophenol, p-nitrobenzene, p-benzoquinone, thiophenol, thiol salt, sodium thiosulfate, phosphate ester, etc.

Antioxidants, as referred to in the present invention, are a class of substances that can prevent the adverse effects of oxygen. They can help capture and neutralize free radicals, thereby removing the damage of free radicals to the human body. In the printing industry, antioxidants are mainly used to protect inks and plastic materials from oxidative degradation, extend the service life of materials, and maintain the color vividness and durability of printed products. Common antioxidants include bis(2,2,6,6-tetramethyl-4-piperidinyl)adipate, BHT (butylated hydroxytoluene), TBHQ (tertiary butyl hydroxybenzene), vitamin E (tocopherol), sulfides, phosphite esters, etc.

Plasticizers are substances added to materials to improve their processability, plasticity, flexibility, and tensile strength. In the printing industry, plasticizers are mainly used to improve the fluidity of inks and the flexibility of plastic films, thereby making printed products smoother and more durable. Common plasticizers include polyethylene glycol (PEG), 1,6-hexanediol diacrylate (HDDA), etc.

Fillers, also known as pigments, are pigments with low covering power and coloring power. They mainly play an increasing role in the body (bone) of inks, such as improving the thickness and wear resistance of the ink film, while having almost no effect on the transparency and color of the ink. In the composition of the present invention, inorganic particles can be used as fillers. Including inorganic coloring pigments such as titanium dioxide, graphite, zinc white; inorganic. Fillers such as calcium carbonate powder, precipitated calcium carbonate, gypsum, clay (China Clay), silicon dioxide powder, diatomite, talc, kaolin, alumina white, barium sulfate, stearic acid aluminum, calcium carbonate, barite powder, polishing powder, etc., and inorganic pigments such as polysilazane, glass beads, etc. These inorganic particles can be used in the ink in the range of 0.1-60% by weight to adjust the coloring or the rheological properties of the ink.

Abrasion-resistant agents are industrial materials mainly used to improve the abrasion resistance and scratch resistance of products, and improve the self-cleaning performance of products. They will not reduce the mechanical properties of the product, and the surface of the product is not greasy and smooth. In the printing industry, abrasion-resistant agents are mainly used to improve the abrasion resistance of inks and plastic materials, especially in materials such as packaging paper and cardboard that need to withstand friction. Common abrasion-resistant agents include polytetrafluoroethylene (PTFE), Fischer-Tropsch wax, polyethylene wax, etc.

Viscosity regulators are a class of chemical agents used to adjust the rheological properties of solutions or dispersed suspensions, divided into thinners and thickeners. They are mainly used to change the viscosity of inks or other printing materials to adapt to different printing conditions and requirements. Common viscosity regulators include silicon dioxide, bentonite, etc.

In the printing industry, pigments are coloring substances composed of fine particles, usually existing in the form of powder, used to give objects various colors and create visual effects. As pigments, common known organic pigments used for coloring can be used, including soluble azo pigments, insoluble azo pigments, condensed azo pigments, metal phthalocyanine pigments, non-metal phthalocyanine pigments, quinacridone pigments, perylene pigments, perinone pigments, isoindolinone pigments, isoindoline pigments, dioxazine pigments, thioindigo pigments, anthraquinone-based pigments, quinacridone yellow pigments, metal complex pigments, diketopyrrolopyrrole pigments, carbon black pigments, and other polycyclic pigments, etc.

The following examples are intended to further illustrate certain preferred embodiments of the invention and are not limiting in nature.

### Examples

The photosensitive composition of the present invention can be used for the preparation of photosensitive curing paint.

In this example, the photosensitive composition of the present invention is used for the preparation of photosensitive curing paint. For convenience of comparison, all implementation examples in this specific implementation mode are prepared according to the formula in Table 1, and the proportions of each substance in the table are weight percentages.

TABLE 1
Reaction Paint System Formula

| Reaction Material Type | wt % |
|---|---|
| Reaction Material (a | 61.50 |
| monomer/oligomer) | |
| Initiator | 14.00 |
| Additive | 11.00 |
| Pigment | 13.5 |
| Total | 100.00 |

In the above table 1, the reaction material is a monomer/oligomer with ethylenic unsaturated double bonds. As disclosed in the specification, the reaction material may further comprise a prepolymer. Further, the reaction material may also comprise a mixture of two or more monomers/oligomers or monomers/oligomers with prepolymers. If it is a mixture system, the sum of multiple reaction materials in the system accounts for 61.5% of the total mass of the reaction material. The monomers/oligomers used in this specific implementation example can be used without special limitation as long as they are monomers/oligomers used in the field of photosensitive curing technology.

The initiator can be a single initiator or a mixed initiator system composed of one or more co-initiators. If it is a mixed initiator system, the sum of multiple initiators in the system accounts for 14% of the total mass of the reaction paint system.

According to the formula in Table 1, specific reactants were selected to configure the reaction paint.

In the following implementation Examples 1 to 10, 3% of Trimethylolpropane Tri(methyl ethoxy)acrylate (TMPEOTA), 5% of Diallyl Phthalate (DPHA), 37.45% of Ditrimethylolpropane Tetraacrylate (DTIMPTA), and 16.05% of Diallyl Isophthalate (ISODAP) are selected as mixed reactants. 2% of polytetrafluoroethylene (PTFE) is selected as the abrasion-resistant agent, 2% of silicon dioxide is selected as the viscosity regulator, 7% of calcium carbonate is selected as the filler, and 13.5% of pigment is selected.

It is to be understood that the types, amounts, and specific compounds of additives or pigments described in the foregoing examples are not intended to limit the scope of the selectable materials. One skilled in the art (Technical personnel) may select suitable additives or pigments based on specific requirements, in accordance with the knowledge and practices commonly known in the field.

The initiators and/or co-initiators used in implementation Examples 1 to 10 are shown in Table 2.

TABLE 2

| | Initiator | | | | | |
|---|---|---|---|---|---|---|
| Example | 979 | 379 | DETX | EMK | 307 | 928 |
| Implementation | 14% | — | — | — | — | — |
| Example 1 | | | | | | |
| Implementation | — | 14% | — | — | — | — |
| Example 2 | | | | | | |
| Implementation | 3% | — | 3% | 2% | — | 6% |
| Example 3 | | | | | | |
| Implementation | 3% | — | 3% | 2% | 6% | — |
| Example 4 | | | | | | |
| Implementation | — | 3% | 3% | 2% | 6% | — |
| Example 5 | | | | | | |
| Implementation | — | 3% | 3% | 2% | — | 6% |
| Example 6 | | | | | | |
| Implementation | 9% | — | 5% | — | — | — |
| Example 7 | | | | | | |
| Implementation | 9% | — | — | 5% | — | — |
| Example 8 | | | | | | |
| Implementation | 9% | — | 3% | 2% | — | — |
| Example 9 | | | | | | |
| Implementation | 3% | — | 1% | 4% | — | 6% |
| Example 10 | | | | | | |

The numerical values presented in the above table represent the percentage by weight of each initiator added to the weight of the paint. A blank entry indicates that the corresponding initiator was not present in the implementation example.

Upon completion of the formulation of the reaction paint according to the specified mixing ratios, various tests were conducted on the respective implementation examples to evaluate their performance characteristics.

TABLE 3
Comparison of Initiator 979 and 379

| | | Implementation | Implementation |
|---|---|---|---|
| Test | | Example 1 | Example 2 |
| Surface Curing Degree | Nail | 5 | 5 |
| (High - Pressure | Scratching | | |
| Mercury Lamp) | | | |
| Deep Curing Degree | Alcohol | 8 | 11 |
| (High - Pressure | Friction | | |
| Mercury Lamp) | | | |
| Surface Curing Degree | Nail | 1 | 2 |
| (LED Lamp) | Scratching | | |
| (LED) | Alcohol | 1 | 1 |
| Deep Curing Degree | Friction | | |
| (LED Lamp) | | | |
| Odor | | Δ | Δ |
| Flow (mm) | 10 s | 29.0 | 28.0 |
| | 60 s | 36.0 | 33.5 |
| | 100 s | 38.5 | 35.5 |
| | Δ | 9.5 | 7.5 |

| | | |
|---|---|---|
| (Pa · s) | 83.2 | 134.8 |

In the Table 3 is presented the comparative evaluation of photosensitive compositions of Implementation Example 1 which is utilizing Initiator 979 and photosensitive composition of Implementation Example 2 which serves as a control that uses 379 as the sole initiator. Both compositions were subjected to curing using high-pressure mercury lamps and LED lamps. The parameters assessed included fluidity, viscosity, and curing performance (both surface and deep layers). The results indicate that under LED lamp curing both compositions exhibited relatively poor surface and deep curing with visible traces appearing after only one scratch or friction. When high-pressure mercury lamps are employed as the light source for curing, the surface and deep curing effects of both examples were comparable. However, the photosensitive composition of Example 1 using initiator 979 demonstrated higher fluidity and lesser viscosity when compared to that of the photosensitive composition of Example 2 using initiator 379. Further, use of 979 as the initiator significantly reduces the viscosity of the resulting paint thereby enhancing the fluidity. This low-viscosity characteristic of the paint using initiator 979 contributes to improved printing efficiency, quality, and cost-effectiveness, which offers significant advantages in the printing industry. These benefits include but are not limited to, the following:
1. Improved printing speed: The enhanced fluidity of the low-viscosity paint using initiator 979 facilitates faster ink transfer onto the printing medium and can cover the surface of the printing material more quickly, thereby improving the overall printing speed.
2. Improved printing quality: The low-viscosity paint using initiator 979 can be more uniformly distributed on the printing surface, minimizing printing defects such as white exposure, reverse pulling, and bubbles, and improving the quality and consistency of printed copies.
3. Reduced material waste: The low-viscosity paint using initiator 979 is easier to control and adjust, and can be more precisely applied to the printing surface, reducing downtime adjustments and inspections during construction, thereby reducing excessive use and waste.
4. Reduced equipment wear: The low-viscosity paint using initiator 979 has less friction on printing equipment, reducing the heat generated during the operation cycle of the equipment, which helps to reduce equipment wear and maintenance costs and extend the service life of the equipment.
5. Simplified cleaning process: The low-viscosity resin using initiator 979 has good compatibility with various cleaning solvents, making it easier to clean and reducing the time and difficulty of cleaning printing equipment and tools, and improving production efficiency.
6. Adaptability to various printing substrates: The low-viscosity resin using initiator 979 has better adaptability and can quickly complete polymerization and curing after receiving energy radiation, thereby enabling the use of various different printing substrates and expanding the application range of printing processes.

Accordingly, the comparative results demonstrate that the use of initiator 979 (Example 1) yields significantly improved performance over initiator 379 (Example 2), thereby indicating the better effects of composition of present invention comprising the initiator 979. Thus, it can be clearly inferred that when initiator 979 is used without benzene amine-like structures, it reduces the potential pollution risks without affecting/reducing the curing effect.

### Curing Speed Test

The paint was prepared according to the following formula as shown in Table 4 comprising of initiator 979 in the range of 1 to 8%. High-pressure mercury lamps or LED lamps were used for irradiation curing.

TABLE 4

| | Ingredient (wt %) | | | | | |
|---|---|---|---|---|---|---|
| | | | | | Number | |
| | | | | | of | |
| | | | | | Curing | Number |
| | | | | | Passes | of |
| | | | | | (High - | Curing |
| | | | Epoxy | | Pressure | Passes |
| | | | Diacry- | | Mercury | (LED |
| Example | DPHA | TMPTA | late | 979 | Lamp) | Lamp) |
| Implementation | 5 | 39 | 60 | 1 | 15 or | 15 or |
| Example 11 | | | | | more | more |
| Implementation | 5 | 38 | 60 | 2 | 13 | 15 or |
| Example 12 | | | | | | more |
| Implementation | 5 | 36 | 60 | 4 | 3 | 13 |
| Example 13 | | | | | | |
| Implementation | 5 | 34 | 60 | 6 | 1 | 5 |
| Example 14 | | | | | | |
| Implementation | 5 | 32 | 60 | 8 | 1 | 3 |
| Example 15 | | | | | | |

The results depicted in the above Table 4 showed that when the content of the photosensitive initiator 979 is 1% by weight, the curing cycles all exceed 15 times under both high-pressure mercury and LED lamp irradiation. When the content of initiator 979 is increased to 2%, the curing cycles under high-pressure mercury lamp irradiation decreases to 13 times, with a continued reduction in curing cycles observed at higher concentrations. Therefore, it can be concluded that there exists a trend: when the initiator 979 content is lower than or equal to 1%, the curing cycles consistently exceed 15 times. When the content of initiator 979 was between 2% and 8%, its initiation speed was relatively suitable under both high-pressure mercury lamps and LED lamps. When the content of initiator 979 was greater than 8%, the increase in curing speed was not significant, but the higher dosage would cause a significant increase in cost, resulting in a decline in comprehensive benefits. Therefore, considering various factors, the content of initiator 979 between 2% and 8% achieved the best effect.

### Addition of 2-Morpholinyl-1-Propanone Derivatives

The photosensitive composition provided by the present invention may use a single initiator as well as a composite initiator system comprising a combination of co-initiators.

To further evaluate the performance of composite initiator systems, Implementation Examples 4 and 5 were taken. Both compositions comprised of 3% by weight of first co-initiator DETX, 2% by weight of second co-initiator EMK, and 6% by weight of third co-initiator 307, and the difference between the two was that the composition of Implementation Example 4 contained 3% by weight of initiator 979, while Implementation Example 5 contained 3% by weight of initiator 379. Both compositions were subjected to curing using high-pressure mercury lamps.

TABLE 5
Comparison of results of tests on photosensitive
composition of Examples 4 and 5

| | | Implementation | Implementation |
|---|---|---|---|
| Test | | Example 4 | Example 5 |
| Surface Curing Degree | Nail | 4.5 | 5 |
| (High - Pressure | Scratching | | |
| Mercury Lamp) | | | |
| Deep Curing Degree | Alcohol | 8 | 7 |
| (High - Pressure | Friction | | |
| Mercury Lamp) | | | |

| | | |
|---|---|---|
| (Pa · s) Viscosity (Pa · s) | 58.4 | 85.7 |

In Table 5 are presented the comparison of results of tests on photosensitive composition of Examples 4 and 5. The results confirm that the observations made with single initiator systems remain applicable to composite initiator systems. The curing effect of the reaction system using the initiator 979 is basically consistent with that using the initiator 379. In addition, after introducing a composite initiator system containing of a third co-initiator 307 or co-initiator 928, the viscosity of the reaction system was significantly reduced. The viscosity of the implementation example 5 containing initiator 379 was reduced to 85.7 Pa·s, and the viscosity of the implementation example 4 containing initiator 979 was reduced to 58.4 Pa·s.

### Addition of Thioxanthone Derivatives or Amine Co-Initiators as Initiators

The present invention further found that the addition of thioxanthone derivatives as co-initiators or amine co-initiators in the reaction system can significantly improve the curing effect of the photosensitive reaction system under LED light excitation. And this effect is particularly evident in the initiator system composed of 979 initiator and thioxanthone derivatives and/or amine co-initiators.

In the photosensitive composition of Implementation Examples 1, 7, and 8, the photosensitive composition of Implementation Example 1 contained 14% of initiator 979, while the photosensitive composition of Implementation Example 7 contained 5% of DETX as co-initiator, and the photosensitive composition of Implementation Example 8 contained 5% of EMK as co-initiator. High-pressure mercury lamps and LED lamps were used as light sources to cure the photosensitive system.

TABLE 6
Comparison of results of tests on photosensitive
composition of Examples 1, 7 and 8

| | | Implementation | Implementation | Implementation |
|---|---|---|---|---|
| | | Example 1 | Example 7 | Example 8 |
| Surface Curing Degree | Nail | 5 | 4.5 | 4.5 |
| (High - Pressure | Scratching | | | |
| Mercury Lamp) | | | | |
| Deep Curing Degree | Alcohol | 8 | 10 | 10 |
| (High - Pressure | Friction | | | |
| Mercury Lamp) | | | | |
| (LED) | Nail | 1 | 5 | 4 |
| Surface Curing Degree | Scratching | | | |
| (LED Lamp) | | | | |
| (LED) | Alcohol | 1 | 17 | 14 |
| Deep Curing Degree | Friction | | | |
| (LED Lamp) | | | | |
| Odor | | Δ | Δ | Δ |
| Flow (mm) | 10 s | 29.0 | 29.5 | 30.0 |
| | 60 s | 36.0 | 36.0 | 36.0 |
| | 100 s | 38.5 | 37.5 | 37.0 |
| | Δ | 9.5 | 8.0 | 7.0 |

| | | | |
|---|---|---|---|
| (Pa · s)Viscosity (Pa · s) | 83.2 | 81.9 | 77.2 |

In Table 6 are presented the comparison of results of tests on photosensitive composition of Examples 1, 7 and 8. The results showed that after adding DETX or EMK as first co-initiators, there was little difference in the curing effect when the composite initiator system was cured using high-pressure mercury lamps. However, when LED lamps were used as the light source for initiation, significant changes occurred in the curing effect. From Implementation Example 1, it can be seen that when the initiator system contains only the initiator 979, the curing effect of the photosensitive cured product under LED lamp curing is poor, and obvious changes occur after only one nail scratch or alcohol friction. However, as shown in Implementation Examples 7 and 8, after adding DETX or EMK as co-initiators to form a composite initiator system, both deep curing degree and surface curing degree showed significant improvement, especially after adding DETX.

Table 7 is showing the comparison of results of tests on the photosensitive compositions of Implementation Examples 3, 4 and 9. In Implementation Examples 3, 4, and 9, all contained the initiator 979 at 3%, 3% of DETX and 2% of EMK as first and second co-initiators respectively, and the difference was that Implementation Example 3 contained 6% of third co-initiator 928 while Implementation Example 4 contained 6% of third co-initiator 307, and Implementation Example 9 did not contain any third co-initiator.

The comparison of results of tests on the photosensitive compositions of Implementation Examples 3, 4, 5, 7, 8, and 9 further showed that when the initiator 979 was combined with first and second co-initiators such as thioxanthone derivatives and amine co-initiators, the curing effect of the photosensitive system under LED lamps was particularly good, while addition of third co-initiators such as initiator 928 or initiator 307 combined with thioxanthone derivatives and amine co-initiators did not have this characteristic. It can be seen that when the reaction system is composed of thioxanthone derivatives or amine co-initiators as first and second co-initiators respectively, along with the initiator 979 (Implementation Examples 7, 8, 9), the product cured under LED lamps requires at least 14 times of alcohol friction to undergo obvious changes. However, when the system further adds 2-morpholinyl-1-propanone derivatives (Implementation Examples 4, 8), the curing effect of the photosensitive system under LED lamps decreases.

TABLE 7
Comparison of results of tests on the photosensitive
composition of Examples 3, 4 and 9

| | | Implementation | Implementation | Implementation |
|---|---|---|---|---|
| Test | | Example 3 | Example 4 | Example 9 |
| Deep Curing Degree | Nail | 4.5 | 4.5 | 5 |
| (High - Pressure | Scratching | | | |
| Mercury Lamp) | | | | |
| Deep Curing Degree | Alcohol | 7 | 8 | 10 |
| (High - Pressure | Friction | | | |
| Mercury Lamp) | | | | |
| Odor | | X | ◯ | Δ |
| (LED) | Nail | 4.5 | 4.5 | 5 |
| Surface Curing Degree | Scratching | | | |
| (LED Lamp) | | | | |
| (LED) | Alcohol | 10 | 8 | 22 |
| Deep Curing Degree | Friction | | | |
| (LED Lamp) | | | | |
| Flow (mm) | 10 s | 29.0 | 29.5 | 30.0 |
| | 60 s | 36.0 | 36.0 | 36.5 |
| | 100 s | 38.0 | 37.0 | 39.0 |
| | Δ | 9.0 | 7.5 | 9.0 |

| | | | |
|---|---|---|---|
| (Pa · s)Viscosity (Pa · s) | 75.5 | 58.4 | 84.4 |

The experimental results illustrated in Table 7 indicate that the addition of a third co-initiator 928 and co-initiator 307 reduces the fluidity of the reaction system, and the addition of initiator 307 can reduce the viscosity more significantly. However, it was also observed that addition of a third co-initiator 928, generates a noticeable odor during the curing process, whereas co-initiator 307 did not produce any significant odor. Odor-free ink printing offer considerable advantages in various application scenarios, particularly in industries and product types with strict odor control requirements, such as the packaging industry for food, drugs, and cosmetics. These industries have extremely high requirements for the safety and hygiene of packaging. Odor-free initiators can prevent the pollution of food by odors or harmful volatile substances in the ink, thereby ensuring the safety and quality of food. At the same time, consumers are very sensitive to the odor of food and cosmetic packaging. Odor-free packaging can improve consumers' trust and satisfaction, and avoid product returns or complaints due to odor problems. Accordingly, the combination of initiator 979 and co-initiator 307 is expected to provide enhanced performance characteristics, particularly in applications where low viscosity and odor-free curing are desirable.

### Yellowing Test

As illustrated in Table 8 below, the effect of different photoinitiators on the color stability of a standard white ink formulation was evaluated. In each formulation 5% by mass of the photoinitiator was added to 95% of standard white ink. Implementation Example 16 employed initiator 979, and Implementation Example 17 employed initiator 379.

TABLE 8

| | 979 | 379 | Standard White Ink |
|---|---|---|---|
| Implementation Example 16 | 5% | — | 95% |
| Implementation Example 17 | = | 5% | 95% |

Following UV curing, the color of the cured samples was measured using a spectrophotometer (manufactured by X-rite company). Table 9 presents the colorimetric data for standard white ink formulations containing different photoinitiators, specifically comparing Implementation Example 16 (initiator 979) and Implementation Example 17 (initiator 379). The total color difference (ΔE) between the standard white ink and each formulation was calculated to assess the degree of color shift. The color difference before and after the addition of the initiator is represented by ΔE. A ΔE value greater than 2 indicates that the color change can be distinguished by the naked eye.

TABLE 9

| | White Ink | Implementation | Implementation |
|---|---|---|---|
| | (Standard) | Example 16 | Example 17 |
| L | 92.59 | 93.29 | 93.03 |
| a | 0.11 | −0.03 | −0.72 |
| b | 1.62 | 1.60 | 3.75 |
| ΔE | — | 0.71 | 2.33 |

The results demonstrate that the formulation using initiator 379 exhibited a ΔE value of 2.33, which exceeds the threshold of 2.0 for perceptible color change by the human eye, indicating a noticeable yellowing effect. In contrast, the composition of Implementation Example 16 with initiator 979 exhibited a ΔE value of only 0.71, suggesting minimal color change. These findings indicate that the use of initiator 979 provides superior color stability and reduced yellowing as compared to the use of initiator 379.

In the aforementioned experiment, the standard white ink refers to a mixture formed by adding titanium dioxide to the diallyl phthalate prepolymer (DAISO DAP) and isophthalic acid diallyl ester prepolymer (ISO-DAP) produced by Daisho Chemical Industry Co., Ltd. in Japan.

Table 10 provides a comparative analysis of the effects of various photosensitive compositions incorporating different initiators or intiator systems on curing degree, viscosity odor, and color. The table evaluates both individual inhibitors (979, 379, DETX, EMK, and 307) and combined intiator systems comprising multiple co-initiators. For all tested compositions, the proportions of non-intiator components were maintained consistent with those specified in Table 1, and the functions of these components are as described in the preceding sections of the specification.

TABLE 10

| | Effect on curing | Effect on | Effect | Effect |
|---|---|---|---|---|
| Initiator/Example no. | time/curing degree | viscosity | on odor | on color |
| Implementation | 1/1/1/1 | 54.4 | ◯ | 0.3 |
| Example 1 | | | | |
| Implementation | 1/1/1/1 | 65.3 | ◯ | 2.73 |
| Example 2 | | | | |
| Co-initiator 1 DETX | uncured/uncured/1/1 | 61 | ◯ | 3.21 |
| @3% | | | | |
| Co-initiator 2 | uncured/uncured/1/1 | 58.1 | ◯ | 2.44 |
| EMK@2% | | | | |
| Co-initiator 3 − 307 @ | 5/uncured/1/1 | 80.7 | ◯ | 0.71 |
| 6% | | | | |
| Implementation | 4.5/8/4.5/8 | 58.4 | ◯ | 4.86 |
| Example 4 | | | | |
| Implementation | 5/7/4.5/7 | 85.7 | Δ | 5.7 |
| Example 5 | | | | |
| 307 (9%) + DETX(3%) + | 5/9/5/6 | 88.6 | Δ | 5.1 |
| EMK (2%) | | | | |

[symbol]

Odor = ◯ → Odor level is acceptable or low. [symbol]
Odor = Δ → Slightly unpleasant or tolerable, but not ideal.

Effect on curing time/curing degree—the curing performance of each initiator/initiator system was evaluated using four distinct metrics, each corresponding to a different light source and depth of cure:
Surface Curing Degree (High-Pressure Mercury Lamp)/Deep Curing Degree (High-Pressure Mercury Lamp)/Surface Curing Degree (LED Lamp)/Deep
Curing Degree (LED Lamp); The term “uncured” indicates failure to cure under the specified condition.

As illustrated in Table 10, when evaluated individually, the co-initiators-namely DETX at 3%, EMK at 2%, or 307 at 6%, showed a lower performance across all measured conditions when compared to the effects observed in combined initiator system. Among the primary initiators tested alone-979 at 3% (Implementation Example 1) and 379 at 3% (Implementation Example 2)-exhibited comparable curing performance; however, intiator 979 yielded significantly lower yellowing (ΔE=0.3) and viscosity (54.4 mPa·s) compared to intiator 379 (ΔE=2.73, viscosity=65.3 mPa·s). Thus, it can be seen that the intiator 979 alone performs better than 379 in terms of color stability and processability.

Notably, Table 10 shows that the composite/mixed initiator system used in Implementation Example 4-comprising intiator 979 (3%), DETX (3%), EMK (2%), and 307 (6%)-exhibited markedly improved and well-balanced performance in comparison to any of the imitators used individually. This system delivered high curing efficiency under both high-pressure mercury and LED light sources (surface and deep), maintained low viscosity (58.4 mPa·s), and minimized odor and yellowing (ΔE=4.86). The degree of improvement observed across multiple performance parameters exceeds the additive effect expected from individual components alone, thereby indicating the presence of a synergistic interaction among initiator 979 and the selected co-initiators. These results support that the composite system, particularly when based on initiator 979, enables enhanced photopolymerization behavior that is not predictable from the performance of the individual component, and represents a significant advancement in the formulation of photosensitive compositions.

It is to be understood that the present invention is not limited by the brand, grade, method of preparation, or treatment process of the aforementioned materials, provided that such variations do not impair the functional effectiveness or technical advantages of the invention.

The experimental processes employed in the above implementation examples are as follows:

### Preparation Process of Photosensitive Ink

According to the formulas in Table 1 and Table 2, the corresponding components were weighed and mixed, and then ground on a three-roll mill to prepare the photosensitive ink.

### Production Method of Printed Matter

The photosensitive ink obtained in the above way was used, and 0.1 ml of ink was evenly applied on the rubber roller and metal roller of the RI printing suitability instrument, and then transferred to the printing paper, covering an area of about 220 cm² with a printing concentration of 1.8 (measured by the concentration meter of X-Rite company).

### Measurement of Reaction Paint Viscosity

The viscosity of the reaction paint was measured using the capillary method in the standard GB/T10247-2008. The Laray viscosity (unit: Pa·s) of each ink was measured at 25° C. using a falling bar viscometer (also called a Falling Rod Viscometer).

### Curing Process of Printed Matter

After the color spreading, the test piece was irradiated with ultraviolet light using a high-pressure mercury lamp or LED lamp. The distance between the lamp and the printed matter was 8-20 cm, and the cumulative light quantity was 30 mJ/cm².

Among them, the high-pressure mercury lamp has a light-emitting wavelength of 200-450 nm and an illumination of 160 W/CM².

The central light-emitting wavelength of the LED lamp is 390 nm, and the(illumination) is 3.5 W/cm².

### Evaluation Method of Curing/Drying Properties

Surface Curing Performance Measurement: The curing property of the cured ink layer was evaluated by scratching the cured ink layer with a fingernail immediately after curing.

Deep Curing Performance Measurement: The curing property of the cured ink layer was evaluated by wiping the cured ink layer with alcohol immediately after curing. The cotton swab was soaked in alcohol, then taken out. After placing it for 5 seconds, the cured ink layer was wiped with a certain force.

Evaluation Standards:
5: Even with strong force scratching, it will not be scratched, and the UV curing is very good.
4.5: If scratched with strong force, some parts will not be scratched, and some parts will be slightly scratched.
4: If scratched with strong force, it will be slightly scratched.
3.5: If scratched with strong force, it will be scratched.
3: If scratched with strong force, it will be obviously scratched.
2: If scratched with weak force, it will be obviously scratched.
1: Even if scratched with weak force, it will be obviously scratched, and the UV curing is poor.

### Evaluation Method of Viscosity (T.V.)

The ink viscosity value T.V. refers to the size of the separation force between the two rollers of the viscometer. The measurement was carried out according to the method stipulated by JIS K5701, using an Ink-O-Meter viscometer, at 25° C. and 400 r.p.m. rotation speed, and the T.V. of the ink was obtained after rotating for 60 seconds.

### Evaluation Method of Reaction Paint Fluidity

The fluidity of the reaction paint was evaluated by the parallel plate viscometer method (parallel plate viscometer), and the measurement was carried out according to the corresponding national standard. The characteristics of the reaction paint (0.5 ml) diffusing into concentric circles under the weight of the(loaded plate) were observed every hour, and the diffusion diameter of the reaction paint was measured after 10 seconds, 60 seconds, and 100 seconds. The change from the 10-second value to the 100-second value is represented by Δ, and the fluidity is evaluated through Δ and the 60-second value. According to the Δ data and the 60-second value, the fluidity of the ink and the(halftone reproducibility) and other printing suitability are judged. Specifically, the VR-5510 parallel plate viscometer manufactured by (Kamijima Manufacturing) can be used.

### Evaluation Method of Cured Coating Odor

The cured color-spread sample was cut into a length of 19 cm and a width of 4 cm. The cut-out was quickly put into a plastic self-sealing bag with a length of 30 cm and a width of 20 cm, and kept in a constant temperature(trough) at 60° C. for 1 hour. Then, the self-sealing bag was placed at room temperature, and the odor intensity of each sample was assessed by 5 odor intensity evaluators on a scale of 10 levels. The average of the odor intensity assessments of the 5 people was taken as the odor intensity of the sample. In addition, the higher the value, the lighter the odor.
O: 10-8; Δ: 7-4; X: 1-3

### Evaluation Method of Yellowing

In the standard white ink, 5% of the initiator was added, and the color was measured using a spectrophotometer (produced by X-rite company) after UV curing. The color difference before and after the addition of the initiator is represented by ΔE. When Δ E is greater than 2, the color change can be distinguished by the naked eye.

The CIELAB color space, also written as L*a*b*, was defined by the International Commission on Illumination (abbreviated as CIE) in 1976. It represents colors with three values: “L” represents perceived brightness, and “a” and “b” represent the four unique colors of human vision: red, green, blue, and yellow. The larger the A E value, the more obvious the yellowing.

### Evaluation Method of Curing Speed

The prepared paint was coated on black and white blank paper with a thickness of about 15 microns using a printing suitability instrument absorb part of the varnish with a dropper, and then spread it down evenly with the ends of a scraper), and cured by passing through the surface to be cured under a high-pressure mercury lamp or LED lamp at a certain speed, and the number of lamp passes required to obtain a good surface (reference ink test surface) and complete curing was recorded. The speed was between 60-400 meters/minute, and the same speed was maintained for each experiment. The above experiment was repeated three times, and the result was averaged.

The 369 initiator mentioned in the present invention refers to 2-benzyl-2-dimethylamino-1-(4-morpholinophenyl)butanone, with the CAS number 119313-12-1, and its structure is as follows:

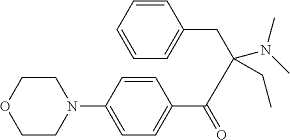 [SMILES: CCC(Cc1ccccc1)(C(=O)c1ccc(N2CCOCC2)cc1)N(C)C]

The 379 initiator mentioned in the present invention refers to 2-dimethylamino-2-(4-methyl)benzyl-1-[4-(4-morpholinyl)pheny-1-butanone, with the CAS number 119344-86-4, and its structure is as follows:

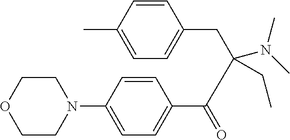 [SMILES: CCC(Cc1ccc(C)cc1)(C(=O)c1ccc(N2CCOCC2)cc1)N(C)C]

The 389 initiator mentioned in the present invention refers to 2-dimethylamino-2-benzyl-1-(4-piperidinophenyl)-1-butanone, with the CAS number 119312-76-4, and its structure is as follows:

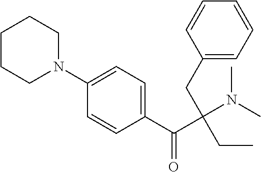 [SMILES: CCC(Cc1ccccc1)(C(=O)c1ccc(N2CCCCC2)cc1)N(C)C]

The 928 initiator mentioned in the present invention refers to 2-methyl-1-(4-methoxyphenyl)-2-morpholinyl-1-propanone, with the CAS number 93216-90-1, and its structure is as follows:

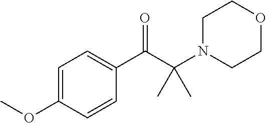 [SMILES: COc1ccc(C(=O)C(C)(C)N2CCOCC2)cc1]

The 307 initiator mentioned in the present invention refers to 2-methyl-1-(4 biphenyl)-2-morpholinyl-1-propanone, with the CAS number 94576-68-8, and its structure is as follows:

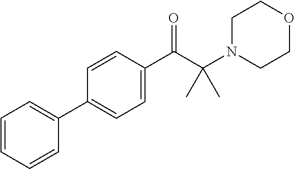 [SMILES: CC(C)(C(=O)c1ccc(-c2ccccc2)cc1)N1CCOCC1]

The DETX initiator mentioned in the present invention refers to 2,4-diethylthioxanthone, with the CAS number 82799-44-8, and its structure is as follows:

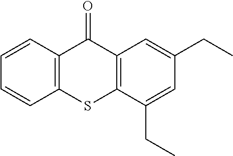 [SMILES: CCc1cc(CC)c2sc3ccccc3c(=O)c2c1]

The EMK initiator mentioned in the present invention refers to 4,4′-bis(diethylamino)benzophenone, with the CAS number 90-93-7, and its structure is

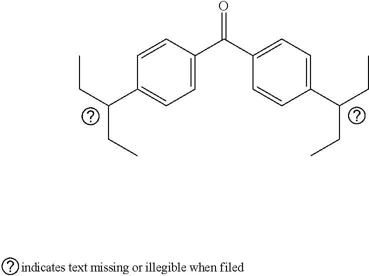 [SMILES: CCC(CC)c1ccc(C(=O)c2ccc(C(CC)CC)cc2)cc1]

as follows:

Among them, TMPEOTA refers to trimethylolpropane tri(methyl ethoxy)acrylate, with the CAS number 28961-43-5. The addition of TMPEOTA can reduce viscosity, and its function is similar to that of a plasticizer.
DPHA refers to pentaerythritol hexaacrylate, with the CAS number 51728-26-8. The addition of this monomer can increase the curing speed.
DTIMPTA refers to ditrimethylolpropane tetraacrylate, with the CAS number 94108-97-1.
ISODAP refers to diallyl isophthalate prepolymer, with the CAS number 25035-78-3.
TMPTA refers to trimethylolpropane triacrylate, with the CAS number 15625-89-5.
Epoxy diacrylate has the CAS number 55818-57-0.
GPTA is the abbreviation for glyceryl triacrylate, with the CAS number 52408-84-1.

The present invention demonstrates that the photosensitive composition comprising initiator 979 and at least one monomer/oligomer wherein the monomer/oligomer is having photopolymerizable ethylenic unsaturated double bonds can achieve non-benzene amine-like substances without reducing the curing effect. This results in a significant reduction in the potential toxicity of the product, while simultaneously achieving low yellowing and low viscosity. Furthermore, it was found that incorporation of additional initiators as co-initiators such as thioxanthone derivatives and/or amine co-initiators to form a composite initiator system significantly improves the curing effect of the photosensitive system under LED light sources. The present invention further found that the addition of 2-morpholinyl-1-propanone derivatives is able to further reduce the viscosity of the reaction system, thereby improving its overall processability. Additionally, the presence of allyl ester prepolymers markedly accelerates the reaction curing speed.

The photoinitiator compounds and curing compositions provided by the present invention are characterized by low production costs, simplified production processes, and simple post-treatment steps while also fulfilling environmental protection requirements. The photoinitiator compositions provided by the present invention effectively reduce the release of various volatile organic compounds (VOCs) in the product, including benzene or toluene, making them particularly suitable for application in the packaging and printing industries of food, tobacco, cosmetics, etc.

It should be emphasized that the foregoing description is intended to illustrate, but not limit, the scope of the present invention. Technical personnel in the field will recognize that various improvements and adaptations/changes may be made to the present invention without deviating from the scope and spirit of the invention.

It should be understood that the present invention is not limited to the above-mentioned illustrative implementation modes. Any modifications, equivalent substitutions, improvements, etc., made by technical personnel in the field within the spirit and principles of the present invention should be included in the protection scope of the present invention.

1. A photosensitive composition, comprising:
(i) a photoinitiator compound having the following structure: 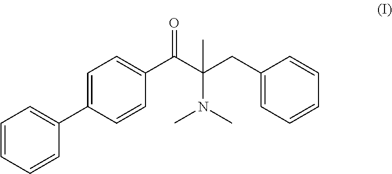 [SMILES: CN(C)C(C)(Cc1ccccc1)C(=O)c1ccc(-c2ccccc2)cc1]
and at least one monomer/oligomer wherein the monomer/oligomer is having photopolymerizable ethylenic unsaturated double bonds;
wherein the photoinitiator compound present is in the range of 1-14% of the weight of the photosensitive composition.

2. The photosensitive composition according to claim 1 wherein the photoinitiator compound is preferably present in the range of 2-8% of the weight of the composition.

3. The photosensitive composition according to claim 1 wherein the composition further comprises one or more additives and pigments.

4. The photosensitive composition according to claim 1 wherein the composition further comprises a first co-initiator.

5. The photosensitive composition according to claim 4 wherein the first co-initiator is a thioxanthone derivative and wherein the said co-initiator is in the range of 1-5% of the weight of the photosensitive composition.

6. The photosensitive composition according to claim 5 wherein the co-initiator has one or more of the following structures:

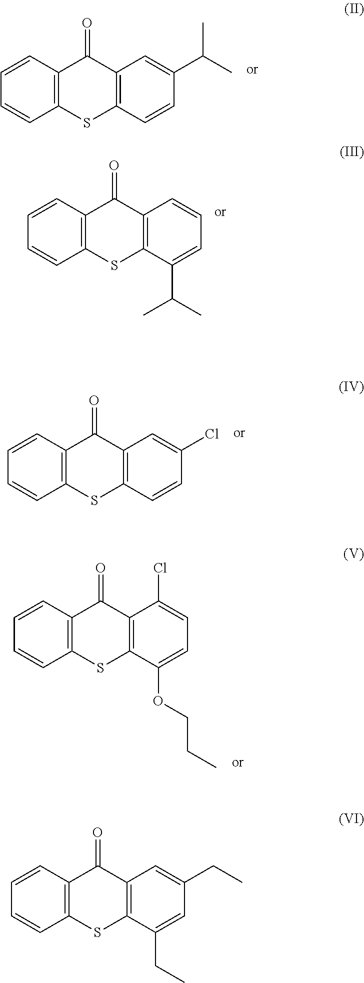

7. The photosensitive composition according to claim 4, further comprising a second co-initiator wherein the second co-initiator is an amine co-initiator and wherein the said amine co-initiator is in the range of 1-5% of the weight of the photosensitive composition.

8. The photosensitive composition according to claim 7 wherein the said amine co-initiator has one or more of the following structures:

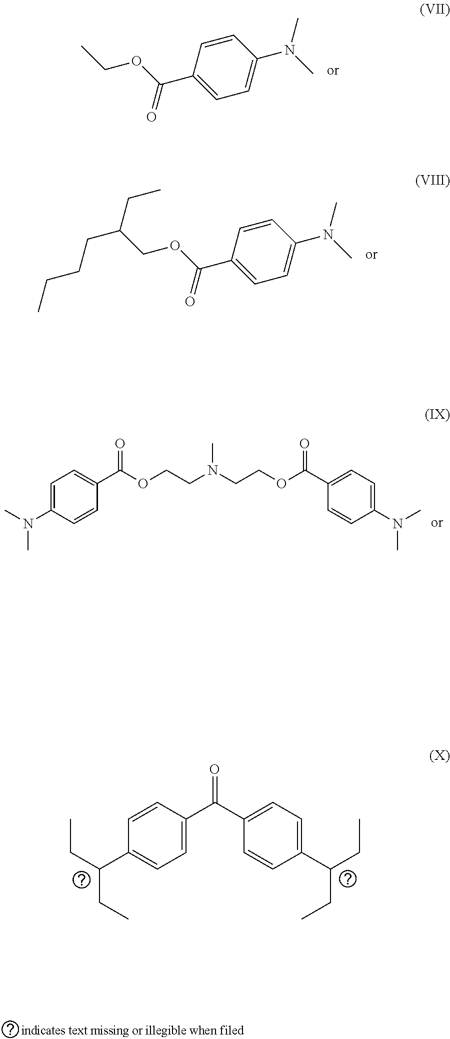

9. The photosensitive composition according to claim 4 wherein the composition further comprises a third co-initiator wherein the third co-initiator is in the range of 1-8% of the weight of the photosensitive composition, and the third co-initiator is a 2-morpholinyl-1-propanone derivative.

10. The photosensitive composition according to claim 9 wherein the third co-initiator has either one or two of the following structures:

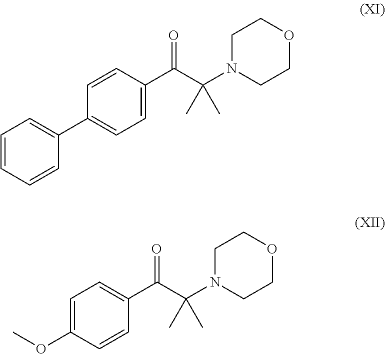 [SMILES: CC(C)(C(=O)c1ccc(-c2ccccc2)cc1)N1CCOCC1 ; COc1ccc(C(=O)C(C)(C)N2CCOCC2)cc1]

11. The photosensitive composition according to claim 1 wherein the composition further comprises an allyl ester prepolymer wherein the said allyl ester prepolymer is in the range of 10-60% of the weight of the photosensitive composition.

12. The photosensitive composition according to claim 11 wherein the allyl ester prepolymer comprises one or more compounds selected from the group consisting of: Diallyl phthalate prepolymer, Diallyl isophthalate prepolymer, Diallyl cyclohexane-1,4-dicarboxylate prepolymer.

13. The photosensitive composition according to claim 1 wherein the said monomer comprises one or more compounds selected from the group consisting of: Trimethylolpropane tri(methyl ethoxy)acrylate, Pentaerythritol hexaacrylate, Ditrimethylolpropane tetraacrylate, Epoxydiacrylate, Trimethylolpropane triacrylate, Glyceryl triacrylate.

14. The photosensitive composition according to claim 2 wherein the additives are selected from the group consisting of: stabilizers, antioxidants, plasticizers, fillers, abrasion-resistant agents, viscosity regulators and wherein the pigments may be selected from the group of consisting of soluble azo pigments, insoluble azo pigments, condensed azo pigments, metal phthalocyanine pigments, non-metal phthalocyanine pigments, quinacridone pigments, perylene pigments, perinone pigments, isoindolinone pigments, isoindoline pigments, dioxazine pigments, thioindigo pigments, anthraquinone-based pigments, quinacridone yellow pigments, metal complex pigments, diketopyrrolopyrrole pigments, carbon black pigments, and other polycyclic pigments.

15. The use of the photosensitive curing composition according to claim 1 in manufacturing printing packaging, electronic adhesives, automotive coatings, building materials, medical devices, dental restorative materials, optical fiber communication coatings, aerospace composite materials, wood coatings, printed circuit boards, optical elements, solar panels, mobile phone screens, display coatings, eyeglass lens coatings, safety glass, anti-counterfeiting labels, textiles, leather products, paper, plastic products, metal anti-corrosion coatings, household appliances, lighting fixtures, automotive interiors, ship interior parts, electronics, jewelry, colored and uncolored paints and varnishes, powder coatings, dental compositions, gel coatings, photoresists for electronic devices, electroplating resists, etching resists, both liquid and dry films, welding resists, photoresists for manufacturing color filters used in various display applications, structures used in the manufacturing methods of plasma display panels, electro luminescent displays and LCD resists, for LCD, holographic data storage, compositions for encapsulating electronic components, for preparing magnetic recording materials, micro-mechanical parts, waveguides, optical switches, forging and covering masks, etching masks, color proofing systems, glass fiber cable coatings, silk screen printing templates, for producing three-dimensional objects using stereolithography, as image recording materials, for holographic recording, microelectronic circuits, decolorizing materials, decolorizing materials for image recording materials, and decolorizing materials used in image recording materials with microcapsules.
